(19) United States
(12) Patent Application Publication
(10) Pub. No.: US 2026/0353451 A1
(43) Pub. Date: Nov. 5, 2026

(54) CONFLICT-AVOIDANCE SENSING CONFIGURATION METHOD, WIRELESS COMMUNICATION DEVICE, AND SYSTEM

(71) Applicant: SHENZHEN TCL NEW TECHNOLOGY CO., LTD., Shenzhen, Guangdong (CN)

(72) Inventor: Zhanjing BAO, Shenzhen, Guangdong (CN)

(73) Assignee: SHENZHEN TCL NEW TECHNOLOGY CO., LTD., Shenzhen, Guangdong (CN)

(21) Appl. No.: 19/478,280

(22) PCT Filed: Apr. 24, 2023
(86) PCT No.: PCT/CN2023/090417

§ 371 Date: Oct. 24, 2025

(51) Int. Cl. H04W 74/0816; H04W 24/08; H04W 84/12

(52) U.S. Cl. CPC H04W 74/0816; H04W 24/08; H04W 84/12

(57) ABSTRACT

A wireless communication system comprises a sensing initiator and one or more sensing responders. The sensing initiator transmits a sensing configuration of wireless local area network (WLAN) sensing (SENS) to the one or more sensing responders. The sensing configuration comprises a time sequence of a sensing service period and a transmission opportunity (TXOP) for the one or more sensing responders based on a periodic sensing task. The sensing initiator receives one or more responses of the sensing configuration from the one or more sensing responders. The one or more sensing responders periodically performs sensing measurements and transmits one or more sensing reports of the sensing measurements from the first sensing responder according to parameters in the sensing configuration. The sensing initiator periodically receives the one or more sensing reports from the one or more sensing responders according to parameters in the sensing configuration.

### TECHNICAL FIELD

The present disclosure relates to the field of communication systems, and more particularly, to a conflict-avoidance sensing configuration method, wireless communication device, and system.

### BACKGROUND ART

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as time, frequency, and power). A wireless network, for example, a wireless local area network (WLAN), such as a WI-FI (institute of electrical and electronics engineers (IEEE) 802.11) network may include an access point (AP) that may communicate with one or more wireless mobile stations (STAs) or devices. The WLAN enables a user to wirelessly access internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, an STA may communicate with an associated AP via downlink and uplink. The downlink may refer to a communication link from the AP to the STA, and the uplink may refer to a communication link from the STA to the AP.

IEEE 802.11 has released a series of international standards related to WLAN. Thus, a WLAN device shall support WLAN communication and other WLAN based functions such as ranging, sensing, positioning, etc. How to efficiently implement these functions and minimize additional channel overhead and device power consumption as much as possible is a challenging issue.

### Technical Problem

The 802.11bf task group proposed a project for WLAN sensing. The sensing session process includes steps performed by a sensing initiator (SI) and a sensing responder (SR) for WLAN sensing, including session setup, measurement setup, measurement instance, measurement termination, and session termination. The measurement instance includes four phases: polling, null data packet announcement (NDPA) sounding, trigger frame (TF) sounding, and reporting.

Each sensing task needs to complete the above steps. For long-term sensing tasks, such as health detection, the sensing process will become cumbersome and introduce unnecessary channel overhead and information transmission delay.

When conducting measurements, devices that serve as sensing responders must remain active and ready to receive instructions from the sensing initiator. This is necessary while the sensing responders are waiting for the initiator to schedule the measurements and configure the devices. Obviously, this is not an energy-saving scheme.

For long-term sensing tasks, it is necessary to resolve channel conflictions between WLAN sensing traffic and WLAN communication traffic to ensure that normal WLAN communication is not affected by WLAN sensing.

Hence, it is desirable to provide a low-power and high-efficiency WLAN sensing method for long-term sensing services.

### Technical Solution

An object of the present disclosure is to propose a conflict-avoidance sensing configuration method, wireless communication device, and system.

A first aspect of the disclosure provides a conflict-avoidance sensing configuration method for execution by a wireless communication device serving as a sensing initiator, comprising:
transmitting a sensing configuration of wireless local area network (WLAN) sensing (SENS), wherein the sensing configuration comprises a time sequence of a sensing service period and a transmission opportunity (TXOP) for one or more sensing responders based on a periodic sensing task;
receiving one or more responses of the sensing configuration from the one or more sensing responders;
periodically receiving one or more sensing reports from the one or more sensing responders according to parameters in the sensing configuration.

A second aspect of the disclosure provides a wireless communication device comprising a memory, a processor and a transceiver. The processor is connected to the transceiver and configured to execute instruction stored in the memory to perform the disclosed method.

A third aspect of the disclosure provides a conflict-avoidance sensing configuration method for execution by a wireless communication device serving as a first sensing responder, comprising:
receiving a sensing configuration of wireless local area network (WLAN) sensing (SENS), wherein the sensing configuration comprises a time sequence of a sensing service period and a transmission opportunity (TXOP) for one or more sensing responders based on a periodic sensing task;
transmitting a response of the sensing configuration;
periodically performing sensing measurements and transmitting one or more sensing reports of the sensing measurements from the first sensing responder according to parameters in the sensing configuration.

In an embodiment, a transmitter circuit and receiver circuit in the wireless communication device is in an active state for WLAN sensing during downlink and uplink occupations in the TXOP in the time sequence and is in an inactive state for WLAN sensing outside of the sensing service periods.

A fourth aspect of the disclosure provides a wireless communication device comprising a memory, a processor and a transceiver. The processor is connected to the transceiver and configured to execute instruction stored in the memory to perform the disclosed method.

A fifth aspect of the disclosure provides a wireless communication system comprising: a sensing initiator; and
one or more sensing responders;
wherein the sensing initiator transmits a sensing configuration of wireless local area network (WLAN) sensing (SENS) to the one or more sensing responders, wherein the sensing configuration comprises a time sequence of a sensing service period and a transmission opportunity (TXOP) for the one or more sensing responders based on a periodic sensing task;
the one or more sensing responders determine whether to accept the sensing configuration and transmit one or more responses to the sensing initiator based on the determination as to whether to accept the sensing configuration;
the sensing initiator receives the one or more responses of the sensing configuration from the one or more sensing responders;
the one or more sensing responders periodically performs sensing measurements and transmits one or more sensing reports of the sensing measurements from the first sensing responder according to parameters in the sensing configuration;
the sensing initiator periodically receives the one or more sensing reports from the one or more sensing responders according to parameters in the sensing configuration.

In an embodiment, a transmitter circuit and receiver circuit in the wireless communication device is in an active state for WLAN sensing during downlink and uplink occupations in the TXOP in the time sequence and is in an inactive state for WLAN sensing outside of the sensing service periods.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

Embodiments of the invention provides a non-competitive conflict-avoidance mechanism using a time sequence. The sensing initiator provides sensing responders with parameters (referred to as sensing configuration parameters or simply parameters) for WLAN sensing in a configuration (referred to as sensing configuration). The sensing configuration parameters comprises time sequence parameters that define a time sequence including conflict-avoidance time allocation for different WLAN services (or different unlicensed band communication services) and non-competitive time allocation for sensing responders. The sensing configuration parameters comprises general parameters and customized parameters.
Periodicity of the sensing service period facilitates sensing responders to perform periodical measurement and reporting in a more low-power and high-efficiency way for long-term WLAN sensing services.
Separation of downlink occupation and uplink occupation in an TXOP can effectively prevent conflicts between uplink and downlink transmission of frames. Td and Tu are allocated to different sensing responders to realize non-competitive time allocation for sensing responders.
A sensing service period interval Ts is allocated for WLAN communication or non-WLAN-sensing services between two sensing service periods. A transmitter circuit and receiver circuit in the wireless communication device is in an active state for WLAN sensing during downlink and uplink occupations in the TXOP in the time sequence and is in an inactive state for WLAN sensing outside of the sensing service periods.
The sensing initiator or the sensing responders do not perform any sensing services during the time period Ts to avoid conflicts between sensing measurements and other services. The interval Ts realize conflict-avoidance time allocation for different unlicensed band communication services.
The disclosed method realizes flexible configuration where the sensing configuration parameters can be modified and updated at any time.
The disclosed method saves channel resources. A single sensing configuration can support long-term multiple measurements, whereby the SI and SR do not need to perform sensing session setup, trigger, polling and other interactive processes for each measurement.

### DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a wireless communications system according to an embodiment of the present disclosure.

FIG. 2 is a schematic diagram illustrating one or more stations (STAs) and an access point (AP) of communication in a wireless communications system according to an embodiment of the present disclosure.

FIG. 3 is a schematic diagram showing a conflict-avoidance sensing configuration method according to an embodiment of the invention.

FIG. 4 is a schematic diagram showing an example where each sensing service period comprises two sensing transmission opportunities (TXOPs), and each TXOP contains one pair of Td and Tu.

FIG. 5 is a schematic diagram showing an example where each sensing service period comprises one sensing TXOPs, and each TXOP contains two pairs of Td and Tu.

FIG. 6 is a schematic diagram showing an embodiment of solution 1 where an AP serves as a sensing initiator, and each sensing service period comprises two sensing TXOPs.

FIG. 7 is a schematic diagram showing an embodiment of solution 2 where an AP serves as a sensing initiator, and each sensing service period comprises one sensing TXOP.

FIG. 8 is a schematic diagram showing an embodiment of solution 1 where a station serves as a sensing initiator, and each sensing service period comprises two sensing TXOPs.

FIG. 9 is a schematic diagram showing an embodiment of solution 2 where a station serves as a sensing initiator, and each sensing service period comprises one sensing TXOP.

FIG. 10 is a block diagram of a system for wireless communication according to an embodiment of the present disclosure.

FIG. 11 is a schematic diagram showing a conflict-avoidance sensing configuration method according to an embodiment of the invention.

FIG. 12 is a schematic diagram showing a conflict-avoidance sensing configuration method according to an embodiment of the invention.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The application provides embodiments of the invention to address the problems in the current specification of WLAN sensing in IEEE 802.11bf.

The following description is directed to certain embodiments for the purposes of describing the innovative aspects of the present disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), global system for mobile communications (GSM), GSM/general packet radio service (GPRS), enhanced data GSM environment (EDGE), terrestrial trunked radio (TETRA), wideband-CDMA (W-CDMA), evolution data optimized (EV-DO), 1×EV-DO, EV-DO Rev A, EV-DO Rev B, high speed packet access (HSPA), high speed downlink packet access (HSDPA), high speed uplink packet access (HSUPA), evolved high speed packet access (HSPA+), long term evolution (LTE), AMPS, or other known signals that are used to communicate within a wireless, cellular or internet of things (IOT) network, such as a system utilizing 3G, 4G, or 5G, or further implementations thereof, technology. Standards in the description may at least refer to one or more versions of the IEEE 802.11 specifications.

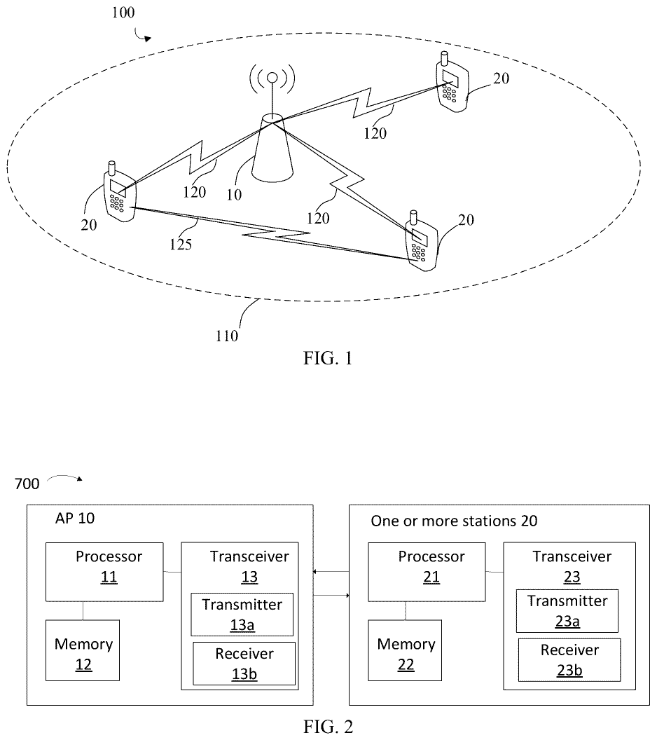

FIG. 1 illustrates an example of a wireless communications system according to an embodiment of the present disclosure. The wireless communications system may be an example of a wireless local area network (WLAN) 100 configured in accordance with various aspects of the present disclosure. The WLAN is also known as a WI-FI network, such as next generation, next big thing (NBT), ultra-high throughput (UHT) or EHT Wi-Fi network. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, an STA 20 may be located in the intersection of more than one coverage area 110 and may associate with more than one AP 10. A single AP 10 and an associated set of STAs 20 may be referred to as a BSS. An ESS is a set of connected BSSs. A distribution system (not shown) may be used to connect APs 10 in an ESS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 126 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, 802.11bf etc. In some other implementations, peer-to-peer connections or ad hoc networks may be implemented within the WLAN 100.

FIG. 2 illustrates one or more stations (STAs) 20 and an access point (AP) 10 of communication in a wireless communications system 700 according to an embodiment of the present disclosure. FIG. 2 illustrates that, the wireless communications system 700 includes an access point (AP) 10 and one or more stations (STAs) 20. The AP 10 may include a memory 12, a transceiver 13, and a processor 11 coupled to the memory 12, the transceiver 13. The one or more STAs 20 may include a memory 22, a transceiver 23, and a processor 21 coupled to the memory 22, the transceiver 23. The transceiver 13 comprises a transmitter 13a and a receiver 13b. The transceiver 23 comprises a transmitter 23a and a receiver 23b. The transmitter 13a can transmit data, control signals, sensing configuration, or sensing reports for reception by the receiver 23b. The transmitter 23a can transmit data, control signals, sensing configuration, or sensing reports for reception by the receiver 13b. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency (RF) signals. When the embodiments are implemented in software, the techniques described herein can be implemented with modules (e.g., instructions, programs, procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 21 is configured to perform the disclosed method in the embodiments of the invention. The STAs in the description, such as STA-a, STA-b, STA-c, STA-d, and STA-e, are examples of a STA 20. The APs in the description, such as AP 100, are examples of the AP 10.

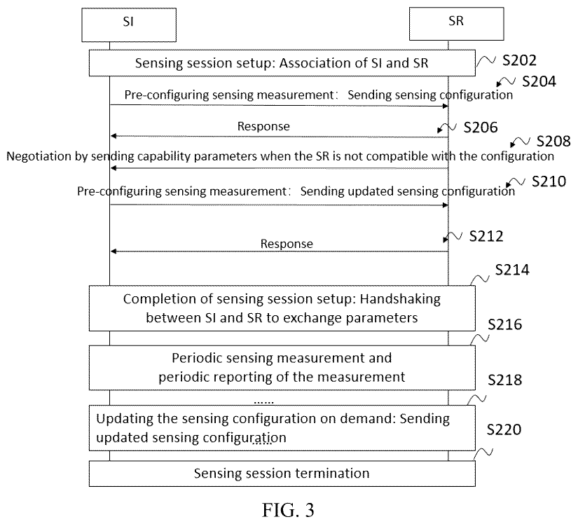

With reference to FIG. 3, an AP may serve as a sensing initiator, and STAs may serve as sensing responders. Alternatively, an STA may serve as a sensing initiator, and an AP and the other STAs may serve as sensing responders.

As shown in the FIG. 3, the overall process is detailed in the following:
1. In a stage of sensing session setup, a sensing initiator (SI) and a plurality of sensing responders (SRs) shall be associated through an association process (S202). For example, stations (STAs) send association request frames to an access point (AP), the AP sends association response frames in response to the association request frames and assigns association IDs (AIDs) to the STAs. Each STA has an assigned AID. In some examples, both an AP and an STA can serve as a sensing initiator (SI) or a sensing responder (SR).
2. In a pre-configuration stage of a sensing procedure, the SI establishes a sensing configuration (e.g., a sensing configuration table) based on periodic sensing tasks and transmits the sensing configuration to SRs (S204). The sensing configuration should include various sensing related parameters, such as sensing transmitter (TX) address (or AID), a receiver (RX) address (or AID), a sub-band bandwidth, a number of antennas, a detection type, a training field repetition number, target receive power, and time sequence parameters. The time sequence parameters include transmission opportunity (TXOP) interval, sensing service period interval, uplink and downlink time within TXOP, testing and reporting time within uplink and downlink time periods . . . (depends on specific implementation methods). The parameters in the sensing configuration may be transmitted in a sensing pre-configuration request frame from the sensing initiator to the one or more sensing responders. Basically, the sensing configuration comprises time sequence parameters including general parameters, and the general parameters indicate one or more of:
   periodicity of the sensing service period; and
   a sensing service period interval between two sensing service periods;
   a number of transmission opportunities, wherein each transmission opportunity comprises one or more uplink occupations and one or more downlink occupations.

The sensing service period interval is allocated for non-WLAN-sensing services. In an example, the WLAN sensing starts at a time point of one short inter-frame space (SIFS) plus one sensing service period interval after completion of a pre-configuration process of for the sensing configuration.

The SI receives one or more responses of the sensing configuration from the one or more sensing responders. The one or more responses of the sensing configuration comprise a response frame sent from a first sensing responder to the sensing initiator, and the response frame comprises:
a response frame shows that the first sensing responder has accepted all the parameters in the sensing configuration;
a response frame that indicates recommended values means that the first sensing responder request modifying the parameters in the sensing configuration according to the recommended values; or
   a response frame shows that the first sensing responder has rejected the sensing configuration for the WLAN sensing operation.
3. If an SR can meet the parameter requirements of the configuration table, it will directly reply with an affirmative response (e.g., a SUCCESS message) to the SI (S206). If the SR are not compatible with any parameters in the sensing configuration, the SR will reply with its corresponding capability parameters to the SI (S208). The SI will update the sensing configuration (e.g., a new configuration table) based on the capability parameters and send the updated sensing configuration to the SR (S210), and SR replies with an affirmative response (e.g., a SUCCESS message) to the SI (S212).
   Of course, there may also be situations where the pre-configuration is not successful. In the situations, when an SR cannot meet the requirements or parameters in the sensing configuration, the SI can no longer retry the pre-configuring, directly send a configuration cancellation message to the current SR and wait for an association request from a suitable SR. Optionally, the SR can directly reject this sensing configuration and send a rejection message to the SI.
4. After the handshake confirmation of the configuration table between SI and SR, the sensing pre-configuration stage is completed (S214).
5. Each SR measures and reports periodically based on the parameters in the configuration table and enters the energy-saving inactive state at other time periods (S216). At this stage, SI or SR can send a request frame at any time to update the sensing configuration parameters (S218).
6. The SRs or SI may terminate the sensing session (S220). There are several ways to terminate the sensing session:
   SR failed to perform sensing measurement and reporting according to the configuration table due to special reasons, resulting in sensing timeout and stop (implicit way)
   SI actively sends termination information to SR to stop sensing (explicit way)
   SI declares the stop time or number of stop rounds for sensing measurement in the configuration table, and automatically stops according to the configuration table (implicit way)

In an embodiment, the WLAN sensing operation for a first sensing responder among the one or more sensing responders is terminated in response to one or more of;
an event showing that the first sensing responder fails to perform sensing measurement or reporting;
a termination instruction sent from the sensing initiator; and
a condition declared by the first sensing responder showing an occasion to terminate the WLAN sensing operation for the first sensing responder.

The condition comprises a stop time or a number of rounds for sensing measurement in the sensing configuration.

### Conflict Avoidance Method:

The invention provides a non-competitive conflict-avoidance mechanism based on a set of time sequence parameters. The sensing initiator provides sensing responders with parameters (referred to as sensing configuration parameters or simply parameters) for WLAN sensing in a configuration (referred to as sensing configuration). The sensing configuration parameters comprises time sequence parameters that define a time sequence including conflict-avoidance time allocation for different WLAN services (or different unlicensed band communication services) and non-competitive time allocation for sensing responders. The sensing configuration parameters comprises general parameters and customized parameters.

There are some general parameters that need to be clarified:

### 1. General Parameters:

All SRs receive the following information as general parameters:
Sensing service period: A sensing service period is the time window for conducting sensing measurement instances. One or more TXOPs for sounding may be allocated within one sensing service period. Two adjacent sensing service periods are spaced apart by an interval Ts. Periodicity of the sensing service period facilitates sensing responders to perform periodical measurement and reporting.
Sensing transmission opportunity (TXOP): Internally, a TXOP is divided into downlink (DL) occupation and uplink (UL) occupation to transmit uplink and downlink frame related to sensing tasks. The number of DL/UL occupations in one TXOP can be one or more.
Td\Tu: Td represents a downlink occupation. Tu represents an uplink occupation. The uplink frame includes null data packet (NDP), report frames, etc., while the downlink frame includes NDP, termination frames, etc. Separation of downlink occupation and uplink occupation in an TXOP can effectively prevent conflicts between uplink and downlink transmission of frames. Td and Tu are allocated to different sensing responders to realize non-competitive time allocation for sensing responders.
Ts: Ts is an interval between any two adjacent sensing service periods. The time period Ts is also a transmission time window for WLAN communication or other services. The sensing initiator or the sensing responders do not perform any sensing services during the time period Ts to avoid conflicts between sensing measurements and other services. The interval Ts realize conflict-avoidance time allocation for different unlicensed band communication services.
Tx: Tx is an interval between any two adjacent TXOPs.

In an embodiment, the time sequence parameters indicate distribution of time for one or more uplink occupations and one or more downlink occupations, the one or more uplink occupations and one or more downlink occupations constitute one transmission opportunity, the distribution of time for one or more uplink occupations and one or more downlink occupations is depicted as a proportion of time allocated to an uplink occupation and a downlink occupation in a transmission opportunity; and the sensing pre-configuration request frame include a field for indicating the proportion.

In an embodiment, the time sequence parameters indicate distribution of time for one or more uplink occupations and one or more downlink occupations, the one or more uplink occupations and one or more downlink occupations constitute one transmission opportunity, the distribution of time for one or more uplink occupations and one or more downlink occupations is depicted as an amount of time devoted to one or more uplink occupations and an amount of time allocated to one or more downlink occupations; and the sensing pre-configuration request frame include a field for indicating the amount of time devoted to one or more uplink occupations and the amount of time allocated to one or more downlink occupations.

In an embodiment, the distribution of time for one or more uplink occupations and one or more downlink occupations is pre-configured in an entry of a configuration table and associated with an index to the entry of the configuration table; and the sensing pre-configuration request frame include a field for indicating the index.

In an embodiment, a transmitter circuit and receiver circuit in the wireless communication device is in an active state for WLAN sensing during sensing service periods in the time sequence and is in an inactive state for WLAN sensing outside of the sensing service periods.

### 2. Customized Parameters for Different SRs:

A sounding type,
A termination method,
A RU assignment,
A measurement time,
A report time within Td or Tu, etc.

Each SR has its own timer. The measurement time and report time is defined with reference to the starting time of a sensing TXOP or a sensing service period, which ensures time synchronization and conflict avoidance. An SR remains in an active state during sensing and reporting and can switch to an inactive state for the rest of the time to save energy.

Active state: In the active state, the transmitter or receiver of an SR are enabled for sending or receiving.

Inactive state: In the inactive state, the receiver and transmitter of an SR are turned off, or the SR only retains the least capability to monitor the channel to realize an energy-saving state of the device.

One or more TXOPs for sounding may be allocated within one sensing service period. In an embodiment, the sensing configuration may indicate a configuration regarding the number of transmission opportunities. A first value of the configuration shows that each sensing service period comprises only one transmission opportunity, and a second value of the configuration shows that each sensing service period comprises a plurality of transmission opportunities. When the configuration shows that each sensing service period comprises a plurality of transmission opportunities, the sensing configuration may comprise time sequence parameters that indicate a transmission opportunity interval between two adjacent transmission opportunities.

### Solution 1: Multiple Sensing TXOPs

In this solution, a sensing service period can contain multiple sensing TXOPs (i.e., a sensing TXOP set) with intervals of Tx, while each sensing TXOP will only contain one Td and one Tu. The next sensing service period is a Ts interval after a previous sensing service period. The SRs can perform periodic and long-term sensing tasks based on these parameters. The timing of the first sensing service period starts at the time point of one SIFS plus one Ts after completion of the pre-configuration stage (i.e., SI has received the last SUCCESS message replied from SRs).
The time sequence parameters include Tu, Td, Tx, and Ts.
Sensing TXOP: Tu+Td.
Sensing service period: ((Td+Tu)*n)+(Tx*(n−1)), when one sensing service period contains n sensing TXOPs, where n depends on actual application.

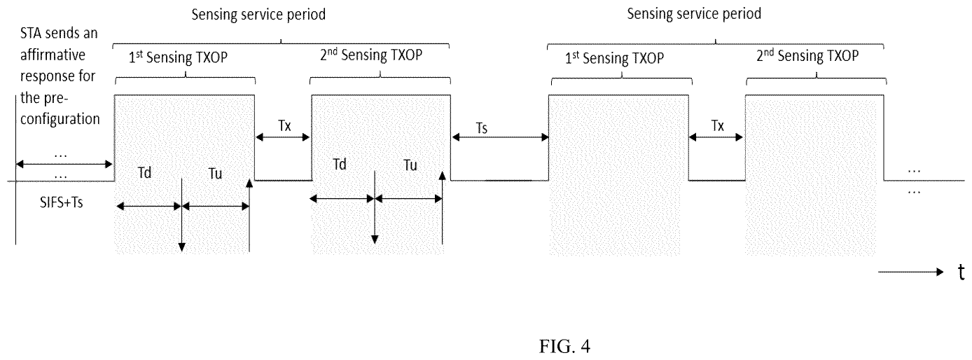

FIG. 4 shows an example where each sensing service period comprises two sensing TXOPs, and each TXOP contains one pair of Td and Tu. The sensing configuration applies to every sensing service period until update of the sensing configuration or termination of the sensing session. An axis t represents a timeline. Although a limited number of sensing service periods are shown in the figures, the time sequence defined by the sensing configuration may comprise more sensing service periods.

### Solution 2: Only One Sensing TXOP.

In this solution, only one sensing TXOP is located within a sensing service period, so there is no Tx parameter. Each TXOP contains multiple pairs of Td and Tu, and their time allocation can be different. The next sensing service period is a Ts interval after a previous sensing service period. The SRs can perform periodic and long-term sensing tasks based on these parameters. The timing of the first sensing service period starts at the time point of one SIFS plus one Ts after completion of the pre-configuration stage (i.e., SI has received the last SUCCESS message replied from SRs).

The timing of the first sensing service period starts at the time point of one SIFS plus one Ts after completion of the pre-configuration stage (i.e., SI has received the last SUCCESS message replied from SRs).
The time sequence parameters include: Tu1, Td1, Ta2, Td2, . . . . Tun, Tdn, and Ts. Each of Tu1, Tu2, . . . and Tun is an instance of uplink occupation Tu. Each of Td1, Td2, . . . and Tdn is an instance of downlink occupation Td.
The length of a sensing service period is exactly equal to the length of a sensing TXOP, which is Td1+Tu1+Td2+Tu2+ . . . +Tdn+Tun, when one TXOP contains a pairs of uplink and downlink occupations, where the variable n depends on the actual application.

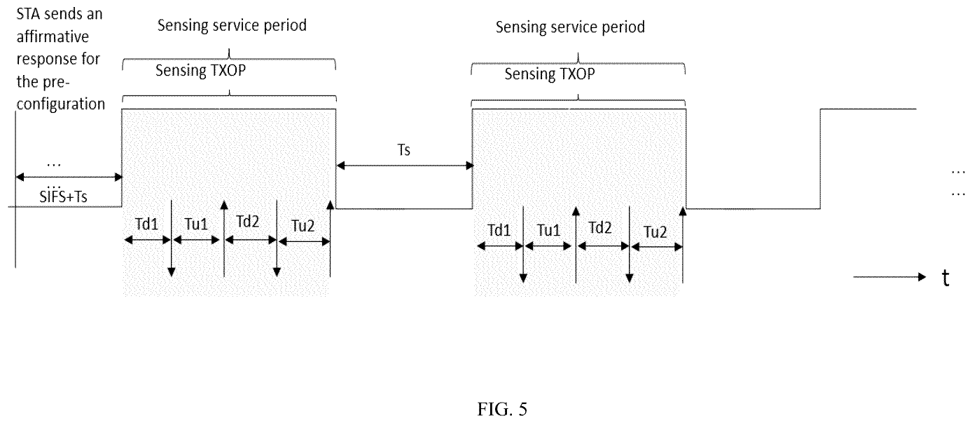

FIG. 5 show an example where each sensing service period comprises one sensing TXOPs, and each TXOP contains two pairs of Td and Tu. The sensing configuration applies to every sensing service period until update of the sensing configuration or termination of the sensing session. An axis t represents a timeline. Although a limited number of sensing service periods are shown in the figures, the time sequence defined by the sensing configuration may comprise more sensing service periods.

### Examples of Transferring Sensing Configuration Parameters

Method 1: An SI sends pre-configuration request frames to SRs, and each pre-configuration request frame comprises all sensing related parameters.

Taking above-mentioned Solution 1 as an example, in the pre-configuration stage, the SI sends a pre-configuration request frame to a SR, and the pre-configuration request frame directly indicates various sensing parameters. For example, in the pre-configuration request frame, Tu is directly indicated as 5 seconds, Td is 3 seconds, measurement time is 1 second, and measurement type is NDPA sounding . . . etc. Second may be abbreviated as s hereafter. The SR provides a response or feedback in a pre-configuration response frame to the SI. An affirmative response (e.g., ‘SUCCESS’) is indicated in the frame shows that the SR has accepted all parameters in the pre-configuration request frame. If the SR needs to modify the parameters, the SR indicates the recommended parameters in the response frame; A non-affirmative response (e.g., ‘DECLINE’) is indicated in the response frame shows that the SR has rejected the pre-configuration request frame.

Method 2: An SI sends pre-configuration request frames to SRs, and each pre-configuration request frame directly comprises a proportion or an index to represent timing sequence parameters.

Taking above-mentioned Solution 1 as an example, the SI sends a pre-configuration request frame to an SR. In the pre-configuration request frame, various sensing related parameters in the frame may be indicated by index values associated with the parameters. As shown in the table below, in the frame, various parameters can be directly indicated by an index. For example, in the pre-configuration request frame, an index 0 in a field indicating sensing TXOP represents a sensing TXOP of 10 seconds, an index 0 in the field indicating a proportion of Td and Tu represents 1:1, that is, Td and Tu are 5s respectively, and an index 0 in the field indicating the sounding type represents TF sounding. Obviously, any pre-configured parameter can be indicated by its index,

TABLE 1
Indexes in a field indicating sensing TXOP.

| Index | Sensing TXOP |
|---|---|
| 0 | 10 s |
| 1 | 20 s |
| . . . | . . . |

TABLE 2
Indexes in a field indicating a proportion of Td and Tu

| index | Td:Tu |
|---|---|
| 0 | 1:1 |
| 1 | 3:2 |
| 2 | 7:3 |
| . . . | . . . |

TABLE 3
Indexes in a field indicating a sounding type.

| Index | Sounding type |
|---|---|
| 0 | TF |
| 1 | NDPA |
| . . . | . . . |

### Embodiment A: An AP Serving as the Sensing Initiator in Solution 1

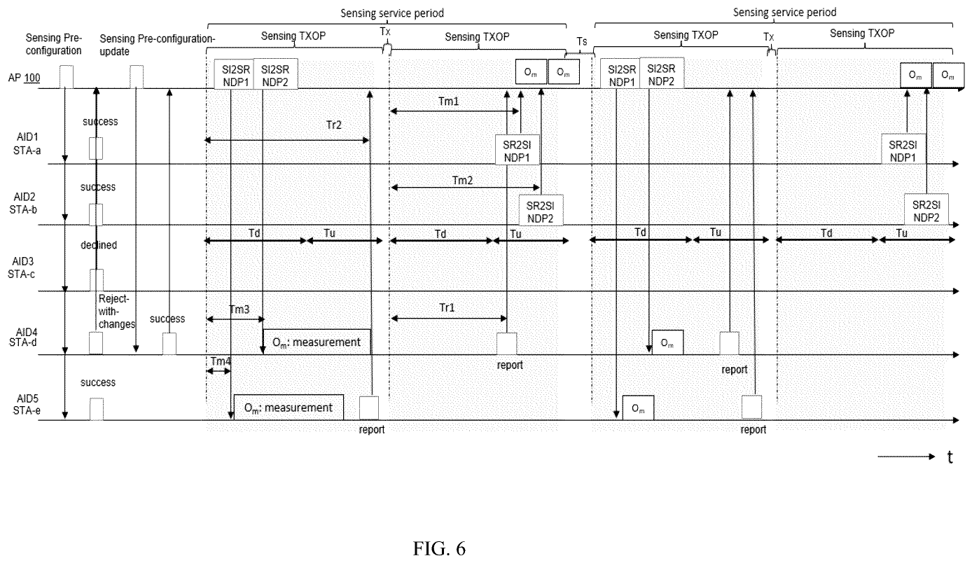

As shown in the FIG. 6, in this embodiment, an access point (AP) 100 serves as the sensing initiator, and a plurality of stations (STAs) serve as the sensing responders. STA-a and STA-b are arranged to perform TF sounding in the second sensing TXOP, but based on the present invention, trigger frames can be omitted; STA-d and STA-e are arranged to perform NDPA sounding in the first sensing TXOP. Om represents a measurement operation for WLAN sensing. SI2SR NDP, such as SI2SR NDP1 and SI2SR NDP2, or I2R NDP is the term used in the IEEE standards and represents an NDP sent from the SI to an SR. SR2SI NDP, such as SR2SI NDP1 and SR2SI NDP2, or R2I NDP is the term used in the IEEE standards and represents an NDP sent from an SR to the SI.

Specifically, the AP 100 transmits pre-configuration request frames to STA-a, STA-b, STA-c, STA-d, and STA-e. Each of the pre-configuration request frames comprises sensing configuration including general parameters and customized parameters. STA-a is configured with a measurement time Tm1. STA-b is configured with a measurement time Tm2. STA-c rejects the sensing configuration. STA-d is configured with a measurement time Tm3 and a report time Tr1. STA-e is configured with a measurement time Tm4 and a report time Tr2.

Since STA-c declined this sensing pre-configuration request frame, a sensing session for STA-c is not successfully set up. STA-d did not agree to the initial sensing parameters in the pre-configuration request frame, so AP 100 updates the sensing parameters and transmits another pre-configuration request frame carrying the updated sensing parameters to STA-d.

Based on the present invention, NDPA frames can be omitted, and both of the SI and SR can directly send NDP frames based on pre-configured parameters without the need for triggering, polling, or scheduling. In a DL occupation, the AP 100 can transmit to STA-d and STA-e NDP frames as well as the termination frames for terminating the sensing sessions. In a UL occupation, STA-a and STA-b may transmit to the AP 100 NDP frames, and STA-d and STA-e may transmit to the AP 100 reporting frames for reporting the measurement in the sensing session.

The AP 100 needs to negotiate the following parameters with each STA during the pre-configuration stage:

TABLE 4

| | Sounding | | Measurement | Report | | | | | RU | |
|---|---|---|---|---|---|---|---|---|---|---|
| AID | type | Termination | time | time | Ts | Tx | Tu | Td | assignment | others |
| 1 | TF | explicit | TXOP2-Tm1 | — | x | y | a | b | RU1 | . . . |
| 2 | TF | implicit | TXOP2-Tm2 | — | | | | | RU2 | . . . |
| 3 | — | — | — | — | | | | | — | . . . |
| 4 | NDPA | implicit | TXOP1-Tm3 | TXOP2-Tr1 | | | | | RU4 | . . . |
| 5 | NDPA | implicit | TXOP1-Tm4 | TXOP1-Tr2 | | | | | RU5 | . . . |

Among the parameters, AID or MAC address is used for addressing STA. As aforementioned, these parameters can be directly indicated or indicated by the index corresponding to the parameters. As shown in the FIG. 6, in the first sensing TXOP, Tm3 and Tm4 are assigned in the DL occupation to indicate time windows for sequential transmission of downstream NDP frames (Tm3>Tm4), and Tr2 is assigned in the UL occupation to indicate a reporting time of STA-e. In the second sensing TXOP, Tm1 and Tm2 are assigned in the UL occupation to indicate time windows for sequential transmission of uplink NDP frames. Tr1 is used to indicate a reporting time of STA-d, and Tr1<Tm1<Tm2.

Specifically, in the first sensing TXOP, Tm3 in the DL occupation of the first sensing TXOP indicates a time for transmission of a DL NDP frame from the AP to STA-d. The AP transmits a downstream NDP frame to STA-d in the time indicated by Tm3. STA-d performs measurement in response to the NDP frame and sends a report of the measurement to the AP on the report time indicated by Tr1 in the second TXOP. The report may be transmitted in an UL occupation in a first sensing TXOP or a second sensing TXOP.

Tm4 in the DL occupation of the first sensing TXOP indicates a time for transmission of a DL NDP frame from the AP to STA-e. The AP transmits a downstream NDP frame to STA-e in the time indicated by Tm4. STA-e performs measurement in response to the NDP frame and sends a report of the measurement to the AP on the report time indicated by Tr2.

In the second sensing TXOP, Tm1 in the UL occupation of the second sensing TXOP indicates a time for transmission of a UL NDP frame from STA-a to the AP. The AP receives the UL NDP frame and performs measurement in response to the UL NDP frame.

Tm2 in the UL occupation of the second sensing TXOP indicates a time for transmission of a UL NDP frame from STA-b to the AP. The AP receives the UL NDP frame and performs measurement in response to the UL NDP frame.

### Embodiment B: AP Serving as the Sensing Initiator in Solution 2

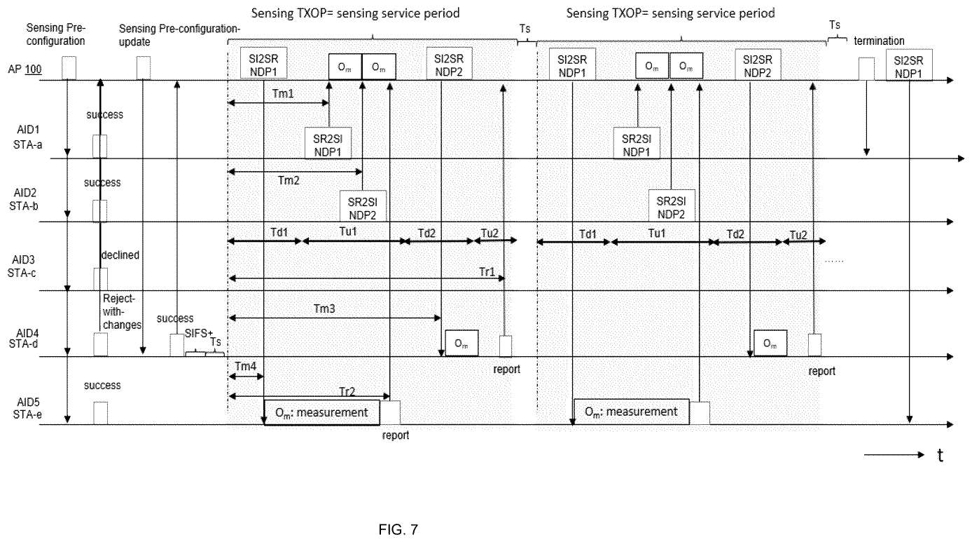

With reference to FIG. 7, different from Embodiment A, in Embodiment B, a sensing service period comprises one TXOP. Similar to the Embodiment A, AP 100 needs to negotiate the following parameters with each STA during pre-configuration:

TABLE 5

| | Sounding | | Measurement | Report | | | | | | RU | |
|---|---|---|---|---|---|---|---|---|---|---|---|
| AID | type | Termination | time | time | Ts | Td1 | Tu1 | Td2 | Tu2 | assignment | Others |
| 1 | TF | explicit | Tm1 | — | x | y1 | z1 | y2 | z2 | RU1 | . . . |
| 2 | TF | implicit | Tm2 | — | | | | | | RU2 | . . . |
| 3 | — | — | — | — | | | | | | — | . . . |
| 4 | NDPA | implicit | Tm3 | Tr1 | | | | | | RU4 | . . . |
| 5 | NDPA | implicit | Tm4 | Tr2 | | | | | | RU5 | . . . |

Each of Tu1, Tu2, . . . and Tun is an instance of uplink occupation Tu. Each of Td1, Td2, . . . and Tdn is an instance of downlink occupation Td.

### Embodiment C: STA Serving as the Sensing Initiator in Solution 1

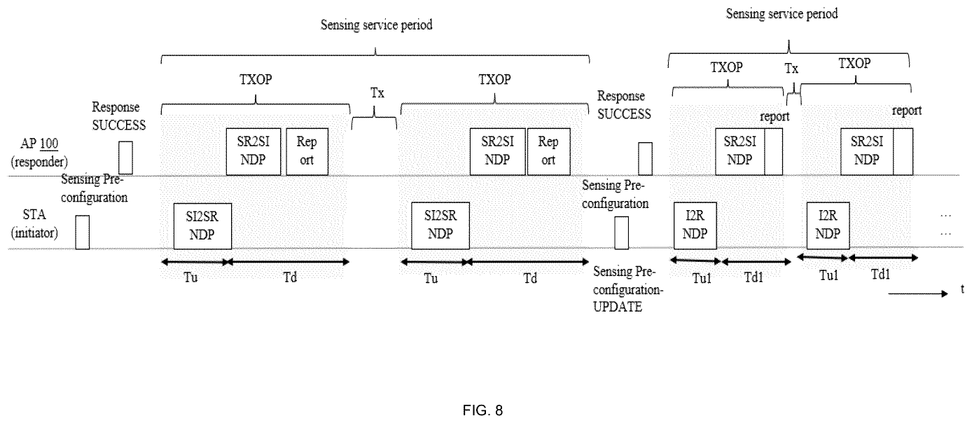

With reference to FIG. 8, in this embodiment, an STA serves as the sensing initiator, and an AP as the sensing responder. NDPs sent from the sensing initiator to the sensing responder are transmitted in UL occupations while NDPs and reports sent from the sensing responder to the sensing initiator are transmitted in the DL occupation. After a sensing service period, the STA updated the sensing pre-configuration parameters, and SI and SR periodically performed sounding and reporting based on the updated parameters (referred to as new parameters).

### Embodiment D: STA Serving as the Sensing Initiator in Solution 2

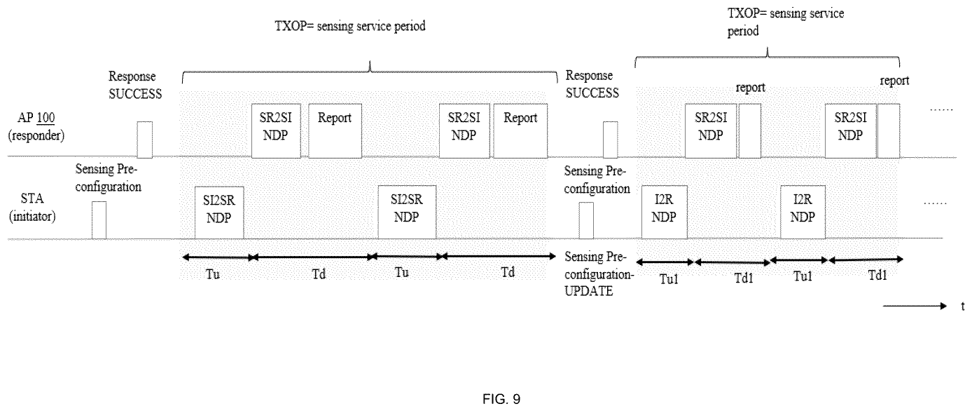

With reference to FIG. 9, different from Embodiment C, in Embodiment D, a sensing service period comprises one TXOP. Similar to Embodiment C, multiple measurements and reports can be performed within a sensing TXOP, and the Td and Tu within a sensing TXOP can be different. The measurement parameters can also be updated in real-time. In this embodiment, an STA serves as the sensing initiator, and an AP as the sensing responder. NDPs sent from the sensing initiator to the sensing responder are transmitted in UL occupations while NDPs and reports sent from the sensing responder to the sensing initiator are transmitted in the DL occupation.

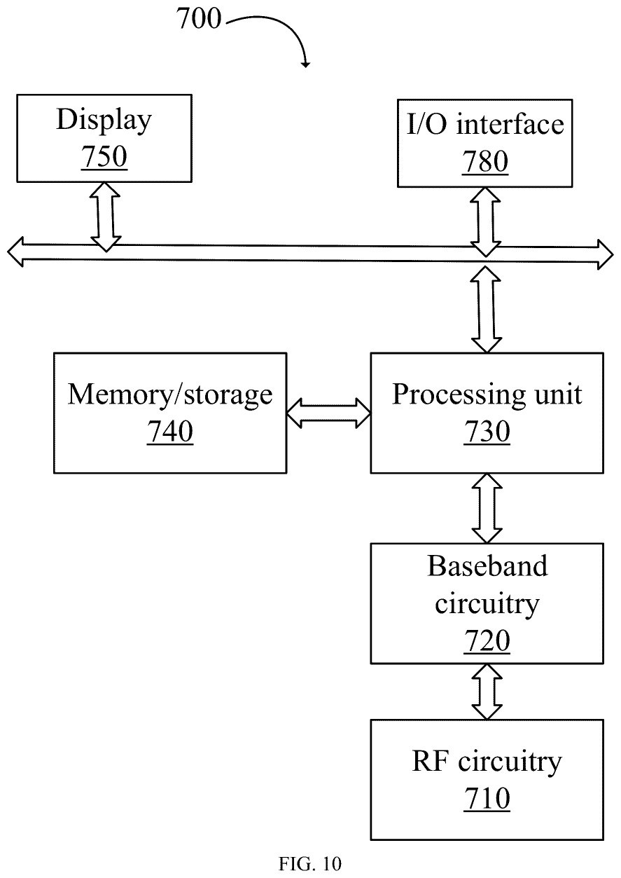

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, a processing unit 730, a memory/storage 740, a display 750, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the MLD, STA or AP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random-access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in IEEE 802.11be specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated into one processing unit, physically independent, or integrated into one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

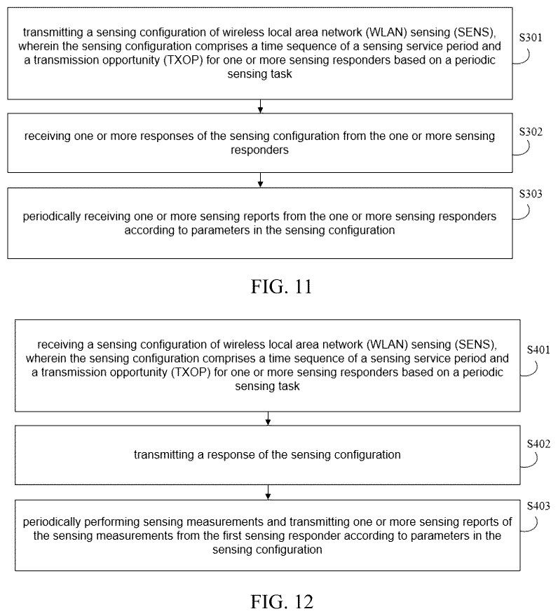

With reference to FIG. 11 and FIG. 12, the conflict-avoidance sensing configuration method may be executed by a wireless communication device, such as AP 10 or an STA 20, serving as a sensing initiator, and a wireless communication device, such as an STA 20 or AP 10, serving as a sensing responder.

The SI transmits a sensing configuration of wireless local area network (WLAN) sensing (SENS), wherein the sensing configuration comprises a time sequence of a sensing service period and a transmission opportunity (TXOP) for one or more sensing responders based on a periodic sensing task (S301). The SR is one of the sensing responders. The SR receives a sensing configuration of wireless local area network (WLAN) sensing (SENS), wherein the sensing configuration comprises a time sequence of a sensing service period and a transmission opportunity (TXOP) for one or more sensing responders based on a periodic sensing task (S401).

The SR transmits a response of the sensing configuration (S402). The one or more sensing responders transmits one or more responses of the sensing configuration to the SI. The SI receives one or more responses of the sensing configuration from the one or more sensing responders (S302).

The SR periodically performs sensing measurements and transmitting one or more sensing reports of the sensing measurements from the first sensing responder according to parameters in the sensing configuration (S403). The SI periodically receives one or more sensing reports from the one or more sensing responders according to parameters in the sensing configuration (S303).

Embodiments of the invention provides a non-competitive conflict-avoidance mechanism using a time sequence. The sensing initiator provides sensing responders with parameters (referred to as sensing configuration parameters or simply parameters) for WLAN sensing in a configuration (referred to as sensing configuration). The sensing configuration parameters comprises time sequence parameters that define a time sequence including conflict-avoidance time allocation for different WLAN services (or different unlicensed band communication services) and non-competitive time allocation for sensing responders. The sensing configuration parameters comprises general parameters and customized parameters.
Periodicity of the sensing service period facilitates sensing responders to perform periodical measurement and reporting in a more low-power and high-efficiency way for long-term WLAN sensing services.
Separation of downlink occupation and uplink occupation in an TXOP can effectively prevent conflicts between uplink and downlink transmission of frames. Td and Tu are allocated to different sensing responders to realize non-competitive time allocation for sensing responders.
A sensing service period interval Ts is allocated for WLAN communication or non-WLAN-sensing services between two sensing service periods. A transmitter circuit and receiver circuit in the wireless communication device is in an active state for WLAN sensing during downlink and uplink occupations in the TXOP in the time sequence and is in an inactive state for WLAN sensing outside of the sensing service periods.
The sensing initiator or the sensing responders do not perform any sensing services during the time period Ts to avoid conflicts between sensing measurements and other services. The interval Ts realize conflict-avoidance time allocation for different unlicensed band communication services.
The disclosed method realizes flexible configuration where the sensing configuration parameters can be modified and updated at any time.
The disclosed method saves channel resources. A single sensing configuration can support long-term multiple measurements, whereby the SI and SR do not need to perform sensing session setup, trigger, polling and other interactive processes for each measurement.

The sensing configuration comprises customized parameters for different sensing responders among the one or more sensing responders, and the customized parameters comprise one or more of:
a measurement time in time sequence parameters,
a report time within a downlink occupation or an uplink occupation in time sequence parameters,
a sounding type,
a termination method,
a resource unit (RU) assignment,
a sensing transmitter (TX) address or association ID (AID),
a receiver (RX) address or AID,
a sub-band bandwidth,
a number of antennas,
a sensing setup ID, and
a long training field (LTF) repetition number, a target reception power.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A conflict-avoidance sensing configuration method for execution by a wireless communication device serving as a sensing initiator, comprising:
transmitting a sensing configuration of wireless local area network (WLAN) sensing (SENS), wherein the sensing configuration comprises a time sequence of a sensing service period and a transmission opportunity (TXOP) for one or more sensing responders based on a periodic sensing task;
receiving one or more responses of the sensing configuration from the one or more sensing responders;
periodically receiving one or more sensing reports from the one or more sensing responders according to parameters in the sensing configuration.

2. The conflict-avoidance sensing configuration method of claim 1, wherein the sensing configuration comprises time sequence parameters including general parameters, and the general parameters indicate one or more of:
periodicity of the sensing service period; and
a sensing service period interval between two sensing service periods;
a number of transmission opportunities, wherein each transmission opportunity comprises one or more uplink occupations and one or more downlink occupations.

3-10. (canceled)

11. The conflict-avoidance sensing configuration method of claim 1, wherein the sensing configuration comprises customized parameters for different sensing responders among the one or more sensing responders, and the customized parameters comprise one or more of:
a measurement time in time sequence parameters,
a report time within a downlink occupation or an uplink occupation in time sequence parameters,
a sounding type,
a termination method,
a resource unit (RU) assignment,
a sensing transmitter (TX) address or association ID (AID),
a receiver (RX) address or AID,
a sub-band bandwidth,
a number of antennas,
a sensing setup ID, and
a long training field (LTF) repetition number, a target reception power.

12. (canceled)

13. The conflict-avoidance sensing configuration method of claim 1, wherein one or more responses of the sensing configuration comprise a response frame sent from a first sensing responder to the sensing initiator, and the response frame comprises:
a response frame shows that the first sensing responder has accepted all the parameters in the sensing configuration;
a response frame that indicates recommended values means that the first sensing responder request modifying the parameters in the sensing configuration according to the recommended values; or
a response frame shows that the first sensing responder has rejected the sensing configuration for the WLAN sensing operation.

14. The conflict-avoidance sensing configuration method of claim 1, wherein the WLAN sensing operation for a sensing initiator or a first sensing responder among the one or more sensing responders is terminated in response to one or more of:
an event showing that the first sensing responder fails to perform sensing measurement or reporting;
a termination instruction sent from the sensing initiator; and
a condition declared by the sensing initiator showing an occasion to terminate the WLAN sensing operation for the first sensing responder.

15. The conflict-avoidance sensing configuration method of claim 14, wherein the condition comprises a stop time or a number of rounds for sensing measurement in the sensing configuration to terminate the sensing session in an implicit way.

16-20. (canceled)

21. A conflict-avoidance sensing configuration method for execution by a wireless communication device serving as a first sensing responder, comprising:
receiving a sensing configuration of wireless local area network (WLAN) sensing (SENS), wherein the sensing configuration comprises a time sequence of a sensing service period and a transmission opportunity (TXOP) for one or more sensing responders based on a periodic sensing task;
transmitting a response of the sensing configuration;
periodically performing sensing measurements and transmitting one or more sensing reports of the sensing measurements from the first sensing responder according to parameters in the sensing configuration.

22. The conflict-avoidance sensing configuration method of claim 21, wherein the sensing configuration comprises time sequence parameters including general parameters, and the general parameters indicate one or more of:
periodicity of the sensing service period; and
a sensing service period interval between two sensing service periods;
a number of transmission opportunities, wherein each transmission opportunity comprises one or more uplink occupations and one or more downlink occupations.

23-30. (canceled)

31. The conflict-avoidance sensing configuration method of claim 21, wherein the sensing configuration comprises customized parameters for different sensing responders among the one or more sensing responders, and the customized parameters comprise one or more of:
a measurement time in time sequence parameters,
a report time within a downlink occupation or an uplink occupation in time sequence parameters,
a sounding type,
a termination method,
a resource unit (RU) assignment,
a sensing transmitter (TX) address or association ID (AID),
a receiver (RX) address or AID,
a sub-band bandwidth,
a number of antennas,
a sensing setup ID, and
a long training field (LTF) repetition number, a target reception power.

32. (canceled)

33. The conflict-avoidance sensing configuration method of claim 21, wherein one or more responses of the sensing configuration comprise a response frame sent from the first sensing responder to the sensing initiator, and the response frame comprises:
a response frame shows that the first sensing responder has accepted all the parameters in the sensing configuration;
a response frame that indicates recommended values means that the first sensing responder request modifying the parameters in the sensing configuration according to the recommended values; or
a response frame shows that the first sensing responder has rejected the sensing configuration for the WLAN sensing operation.

34. The conflict-avoidance sensing configuration method of claim 21, wherein the WLAN sensing operation for a sensing initiator or a first sensing responder among the one or more sensing responders is terminated in response to one or more of:
an event showing that the first sensing responder fails to perform sensing measurement or reporting;
a termination instruction sent from the sensing initiator; and
a condition declared by the sensing initiator showing an occasion to terminate the WLAN sensing operation for the first sensing responder.

35. The conflict-avoidance sensing configuration method of claim 34, wherein the condition comprises a stop time or a number of rounds for sensing measurement in the sensing configuration to terminate the sensing session in an implicit way.

36-40. (canceled)

41. A wireless communication system comprising:
a sensing initiator; and
one or more sensing responders;
wherein the sensing initiator transmits a sensing configuration of wireless local area network (WLAN) sensing (SENS) to the one or more sensing responders, wherein the sensing configuration comprises a time sequence of a sensing service period and a transmission opportunity (TXOP) for the one or more sensing responders based on a periodic sensing task;
the one or more sensing responders determine whether to accept the sensing configuration and transmit one or more responses to the sensing initiator based on the determination as to whether to accept the sensing configuration;
the sensing initiator receives the one or more responses of the sensing configuration from the one or more sensing responders;
the one or more sensing responders periodically performs sensing measurements and transmits one or more sensing reports of the sensing measurements from the first sensing responder according to parameters in the sensing configuration;
the sensing initiator periodically receives the one or more sensing reports from the one or more sensing responders according to parameters in the sensing configuration.

42. The wireless communication system of claim 41, wherein the sensing configuration comprises time sequence parameters including general parameters, and the general parameters indicate one or more of:
periodicity of the sensing service period; and
a sensing service period interval between two sensing service periods;
a number of transmission opportunities, wherein each transmission opportunity comprises one or more uplink occupations and one or more downlink occupations.

43-50. (canceled)

51. The wireless communication system of claim 41, wherein the sensing configuration comprises customized parameters for different sensing responders among the one or more sensing responders, and the customized parameters comprise one or more of:
a measurement time in time sequence parameters,
a report time within a downlink occupation or an uplink occupation in time sequence parameters,
a sounding type,
a termination method,
a resource unit (RU) assignment,
a sensing transmitter (TX) address or association ID (AID),
a receiver (RX) address or AID,
a sub-band bandwidth,
a number of antennas,
a sensing setup ID, and
a long training field (LTF) repetition number, a target reception power.

52. (canceled)

53. The wireless communication system of claim 41, wherein one or more responses of the sensing configuration comprise a response frame sent from a first sensing responder to the sensing initiator, and the response frame comprises:
a response frame shows that the first sensing responder has accepted all the parameters in the sensing configuration;
a response frame that indicates recommended values means that the first sensing responder request modifying the parameters in the sensing configuration according to the recommended values; or
a response frame shows that the first sensing responder has rejected the sensing configuration for the WLAN sensing operation.

54. The wireless communication system of claim 41, wherein the WLAN sensing operation for a sensing initiator or a first sensing responder among the one or more sensing responders is terminated in response to one or more of:
an event showing that the first sensing responder fails to perform sensing measurement or reporting;
a termination instruction sent from the sensing initiator; and
a condition declared by the sensing initiator showing an occasion to terminate the WLAN sensing operation for the first sensing responder.

55. The wireless communication system of claim 54, wherein the condition comprises a stop time or a number of rounds for sensing measurement in the sensing configuration to terminate the sensing session in an implicit way.

56-60. (canceled)
